(19) United States
(12) Patent Application Publication
(10) Pub. No.: US 2018/0345759 A1
(43) Pub. Date: Dec. 6, 2018

(54) VEHICLE

(71) Applicant: HONDA MOTOR CO., LTD., Tokyo (JP)

(72) Inventor: Jin OKUMURA, Saitama (JP)

(73) Assignee: HONDA MOTOR CO., LTD., Tokyo (JP)

(21) Appl. No.: 15/781,221

(22) PCT Filed: Nov. 4, 2016
(86) PCT No.: PCT/JP2016/082881

§ 371 Date: Jun. 4, 2018

(30) Foreign Application Priority Data
Dec. 4, 2015 (JP) 2015-237805

(51) Int. Cl. B60H 1/04; B62D 25/20; B60K 11/06; B60K 11/08; B60K 1/04

(52) U.S. Cl. CPC B60H 1/04; B62D 25/20; B60L 11/1877; B60K 11/08; B60K 1/04; B60K 11/06

(57) ABSTRACT

A vehicle V includes: a floor panel 16 that forms a floor of a passenger compartment 11; a carpet 20 that is laid on the floor panel 16; a rear seat 10 that is disposed at a rear part of the passenger compartment 11; a high-voltage device accommodating body P that is disposed below the rear seat 10 and accommodates a high-voltage device D; and an exhaust flow path F that exhausts cooling air used to cool down the high-voltage device D from the high-voltage device accommodating body P. In the vehicle, a vehicle-width-direction space S1, S2 is formed between the high-voltage device accommodating body P and the carpet 20 along a vehicle width direction, and the exhaust flow path F communicates with the vehicle-width-direction space S1, S2.

### TECHNICAL FIELD

The present invention relates to a vehicle including a high-voltage device accommodating portion.

### BACKGROUND ART

Vehicles such as HEV (Hybrid Electrical Vehicle) and EV (Electrical Vehicle) are equipped with a high-voltage device accommodating portion that accommodates a high-voltage device such as a battery (high voltage battery), a DC-DC converter, or an inverter (for example, see Patent Literature 1).

In order to prevent performance deterioration of the high-voltage device due to an abnormal temperature rise, these types of vehicles include a cooling unit for maintaining a temperature of the high-voltage device within an appropriate range. In the vehicle disclosed in Patent Literature 1, for example, the cooling air is taken into the high-voltage device accommodating portion, which is disposed at the lower part on the rear side of the rear seat, from the passenger compartment, and the cooling air used to cool down the high-voltage device is dispersedly exhausted to the passenger compartment and the luggage compartment.

### PRIOR ART LITERATURE

### Patent Literature

Patent Literature 1: JP-A-2008-141945

### SUMMARY OF THE INVENTION

### Problem that the Invention is to Solve

In this type of vehicle, however, even when the cooling air used to cool down the high-voltage device is dispersedly exhausted to the passenger compartment and the luggage compartment, there is a fear that the passengers may feel uncomfortable when the exhaust (hot air) is unbalanced. In the following description, the cooling air used to cool down the high-voltage device and exhausted from the high-voltage device accommodating portion into the vehicle is appropriately referred to as “cooling exhaust”.

The present invention provides a vehicle capable of reducing uncomfortable feeling of passengers due to unbalanced cooling exhaust by dispersing the cooling exhaust of a high-voltage device in a vehicle width direction.

### Means for Solving the Problem

The present invention is to provide the following aspects.

A first aspect defines a vehicle (e.g., a vehicle V in an embodiment to be described below) including:

a floor panel (e.g., a front floor panel 16 in the embodiment to be described below) that forms a floor of a passenger compartment (e.g., a passenger compartment 11 in the embodiment to be described below)

a carpet (e.g., a carpet 20 in the embodiment to be described below) that is laid on the floor panel;

a rear seat (e.g., a rear seat 10 in the embodiment to be described below) that is disposed at a rear part of the passenger compartment;

a high-voltage device accommodating portion (e.g., a high-voltage device accommodating body P in the embodiment to be described below) that is disposed below the rear seat and accommodates a high-voltage device (e.g., a high-voltage device D in the embodiment to be described below);

an exhaust flow path (e.g., an exhaust flow path F in the embodiment to be described below) that exhausts cooling air used to cool down the high-voltage device from the high-voltage device accommodating portion, wherein

a vehicle-width-direction space (e.g., vehicle-width-direction spaces S1 and S2 in the embodiment to be described below) is formed between the high-voltage device accommodating portion and the carpet along a vehicle width direction, and

the exhaust flow path communicates with the vehicle-width-direction space.

A second aspect defines, based on the first aspect, the vehicle, wherein

the vehicle-width-direction space (S1) is formed between a front surface of the high-voltage device accommodating portion and the carpet.

A third aspect defines, based on the first aspect, the vehicle, wherein

the vehicle-width-direction space (S2) is formed between a front surface of a kick-up portion (e.g., a kick-up portion 16a in the embodiment to be described below) rising from a rear end of the floor panel and the carpet.

A fourth aspect defines, based on any one of the first to third aspects, the vehicle, wherein

a branch member (e.g., a branch duct 14 in the embodiment to be described below) that branches the exhaust flow path into a right front exhaust flow path (e.g., a right front exhaust flow path F1 in the embodiment to be described below), a left front exhaust flow path (e.g., a left front exhaust flow path F2 in the embodiment to be described below), and a rear exhaust flow path (e.g., a rear exhaust flow path F3 in the embodiment to be described below), wherein

the cooling air is exhausted into an inside of the vehicle through the right front exhaust flow path, the left front exhaust flow path, and the rear exhaust flow path.

A fifth aspect defines, based on the fourth aspect, the vehicle further including:

a right vehicle body portion (e.g., a right vehicle body portion 18R in the embodiment to be described below) that rises from a right end of the floor panel;

a left vehicle body portion (e.g., a left vehicle body portion 18L in the embodiment to be described below) that rises from a left end of the floor panel;

a right front-rear-direction space (e.g., a right front-rear-direction space S3 in the embodiment to be described below) that is formed along a vehicle front-rear direction between the right vehicle body portion and the carpet; and

a left front-rear-direction space (e.g., a left front-rear-direction space S4 in the embodiment to be described below) that is formed along the vehicle front-rear direction between the left vehicle body portion and the carpet, wherein

the branch member is disposed on a right side of the high-voltage device accommodating portion,

the right front exhaust flow path communicates with the right front-rear-direction space,

the left front exhaust flow path communicates with the left front-rear-direction space through the vehicle-width-direction space, and

the rear exhaust flow path communicates with a rear exhaust duct (e.g., a rear exhaust duct 21 in the embodiment to be described below) directed toward a right rear side of the vehicle.

A sixth aspect defines, based on the fourth aspect, the vehicle further including:

a right vehicle body portion (e.g., a right vehicle body portion 18R in the embodiment to be described below) that rises from a right end of the floor panel;

a left vehicle body portion (e.g., a left vehicle body portion 18L in the embodiment to be described below) that rises from a left end of the floor panel;

a right front-rear-direction space (e.g., a right front-rear-direction space S3 in the embodiment to be described below) that is formed along a vehicle front-rear direction between the right vehicle body portion and the carpet; and

a left front-rear-direction space (e.g., a left front-rear-direction space S4 in the embodiment to be described below) that is formed along the vehicle front-rear direction between the left vehicle body portion and the carpet, wherein

the branch member is disposed on a left side of the high-voltage device accommodating portion,

the left front exhaust flow path communicates with the left front-rear-direction space,

the right front exhaust flow path communicates with the right front-rear-direction space through the vehicle-width-direction space, and

the rear exhaust flow path communicates with a rear exhaust duct (e.g., a rear exhaust duct 21 in the embodiment to be described below) directed toward a left rear side of the vehicle.

A seventh aspect defines, based on the fifth or sixth aspect, the vehicle further including:

a heater duct (a heater duct 19 in the embodiment to be described below) that blows warm air into a foot space of the passenger compartment, wherein

the right front-rear-direction space and the left front-rear-direction space communicate with a duct peripheral space (e.g., duct peripheral spaces S5 and S6 in the embodiment to be described below) formed between the heater duct and the carpet, and

the cooling air in the right front-rear-direction space and the left front-rear-direction space is exhausted to the passenger compartment through the duct peripheral spaces.

An eighth aspect defines, based on any one of the fifth to seventh aspects, the vehicle, wherein

the carpet includes an exhaust hole (e.g., an exhaust hole 20e in the embodiment to be described below) through which the cooling air in the right front-rear-direction space and the left front-rear-direction space is exhausted to the passenger compartment.

A ninth aspect defines a vehicle (e.g., a vehicle V in an embodiment to be described below) including:

a rear seat (e.g., a rear seat 10 in the embodiment to be described below) that is disposed at a rear part of a passenger compartment (e.g., a passenger compartment 11 in the embodiment to be described below);

a high-voltage device accommodating portion (e.g., a high-voltage device accommodating body P in the embodiment to be described below) that is disposed below the rear seat and accommodates a high-voltage device (e.g., a high-voltage device D in the embodiment to be described below);

an exhaust flow path (e.g., an exhaust flow path F in the embodiment to be described below) that exhausts cooling air used to cool down the high-voltage device from the high-voltage device accommodating portion, wherein

the vehicle further includes a branch member that branches the exhaust flow path into a right front exhaust flow path (e.g., a right front exhaust flow path F1 in the embodiment to be described below), a left front exhaust flow path (e.g., a left front exhaust flow path F2 in the embodiment to be described below), and a rear exhaust flow path (e.g., a rear exhaust flow path F3 in the embodiment to be described below and

the cooling air is exhausted into the vehicle through the right front exhaust flow path, the left front exhaust flow path, and the rear exhaust flow path.

A tenth aspect defines, based on the ninth aspect, the vehicle, wherein

the branch member branches the exhaust flow path into one of the left front exhaust flow path and the right front exhaust flow path at a first branch portion (e.g., a first branch portion 14a in the embodiment to be described below), and branches the exhaust flow path into the other of the left front exhaust flow path and the right front exhaust flow path and the rear exhaust flow path at a second branch portion (e.g., a second branch portion 14b in the embodiment to be described below) in a downstream of the first branch portion.

An eleventh aspect defines, based on the ninth or tenth aspect, the vehicle, wherein

the high-voltage device accommodating portion accommodates a cooling fan (e.g., a cooling fan 8 in the embodiment to be described below) therein,

the cooling fan includes a fan casing (e.g., a fan casing 8a in the embodiment to be described below), a rotating fan (e.g., a rotating fan 8b in the embodiment to be described below) installed in the fan casing, and a motor (e.g., a motor 8c in the embodiment to be described below) disposed at a center of the rotating fan to drive rotation of the rotating fan,

an intake port (e.g., an intake port 8d. in the embodiment to be described below) is formed at a lower surface of the fan casing which is a direction of a rotation axis of the rotating fan,

an exhaust port (e.g., an exhaust port 8e in the embodiment to be described below) is formed at a side surface of the fan casing so as to extend along a tangential direction of the rotating fan, and

the cooling fan is disposed such that the exhaust port faces obliquely upward toward the branch member.

### Advantage of the Invention

According to the first aspect, since the exhaust flow path of the cooling air used to cool down the high-voltage device communicates with the vehicle-width-direction space along the vehicle width direction, it is possible to disperse the cooling exhaust of the high-voltage device in the vehicle width direction and to reduce the uncomfortable feeling of the passenger due to the unbalanced cooling exhaust. In addition, since the vehicle-width-direction space is formed between the high-voltage device accommodating portion and the carpet, it is possible to disperse the cooling exhaust in the vehicle width direction in a space-saving manner and at a low cost.

According to the second aspect, the cooling exhaust of the high-voltage device can be dispersed in the vehicle width direction using the vehicle-width-direction space formed between the front surface of the high-voltage device accommodating portion and the carpet.

According to the third aspect, the cooling exhaust of the high-voltage device can be dispersed in the vehicle width direction using the vehicle-width-direction space formed between the front surface of the kick-up portion rising from the rear end of the front floor panel and the carpet.

According to the fourth aspect, since the cooling exhaust of the high-voltage device is dispersed in three directions through the right front exhaust flow path, the left front exhaust flow path, and the rear exhaust flow path, not only the uncomfortable feeling of the passenger due to the unbalanced cooling exhaust can be further reduced but also exhaust noise can be reduced.

According to the fifth and sixth aspects, the cooling exhaust of the high-voltage device can be further dispersed using the right front-rear-direction space formed between the right vehicle body portion and the carpet or the left front-rear-direction space formed between the left vehicle body portion and the carpet.

According to the seventh aspect, the cooling air in the right front-rear-direction space and the left front-rear-direction space can be dispersedly exhausted to the passenger compartment using the duct peripheral spaces.

According to the eighth aspect, the cooling air in the right front-rear-direction space and the left front-rear-direction space can be dispersedly exhausted to the passenger compartment from the exhaust hole of the carpet.

According to the ninth aspect, since the cooling exhaust of the high-voltage device is dispersed in three directions through the right front exhaust flow path, the left front exhaust flow path, and the rear exhaust flow path, not only the uncomfortable feeling of the passenger due to the unbalanced cooling exhaust can be further reduced but also exhaust noise can be reduced.

According to the tenth aspect, since the branch member branches the exhaust flow path into one of the left front exhaust flow path and the right front exhaust flow path at the first branch portion, and branches it into the other of the left front exhaust flow path and the right front exhaust flow path and the rear exhaust flow path at the second branch portion in a downstream of the first branch portion, the cooling exhaust can be efficiently dispersed in three directions compared with the case of dispersing the cooling exhaust in three directions at one branch portion.

According to the eleventh aspect, the cooling air used to cool down the high-voltage device can smoothly flow toward the branch member and the pressure loss can be reduced.

### BRIEF DESCRIPTION OF DRAWINGS

FIG. 1 is a perspective view of a floor covered with a carpet and a high-voltage device accommodating body when viewed obliquely from an upper rear side in a vehicle according to an embodiment.

FIG. 2 is a perspective view of the floor from which the carpet is removed and the high-voltage device accommodating body of the vehicle when viewed obliquely from an upper front side.

FIG. 3 is an exploded perspective view of the floor from which the carpet is removed and the high-voltage device accommodating body from which the branch duct is removed and which is floated from an accommodation recess, when viewed obliquely from the upper front side.

FIG. 4 is a cross-sectional view taken along line X-X in FIG. 2.

FIG. 5 is a plan view of a main part of the high-voltage device accommodating body.

FIG. 6 is a cross-sectional view taken along line Y-Y in FIG. 5.

FIG. 7 is a perspective view illustrating an exhaust hole of the carpet.

FIG. 8 is a front view illustrating a duct peripheral space.

### MODE OR CARRYING OUT THE INVENTION

Hereinafter, a vehicle according to an embodiment of the present invention will be described by reference to the drawings. The drawings should be seen in a direction in which given reference numerals look normal. In the following description, front, rear, left, right, up and down denote accordingly directions as seen from a driver of the vehicle. The front, rear, left, right, up and clown sides of the vehicle are denoted by Fr, Rr, L, R, U and D, respectively,

[Vehicle]

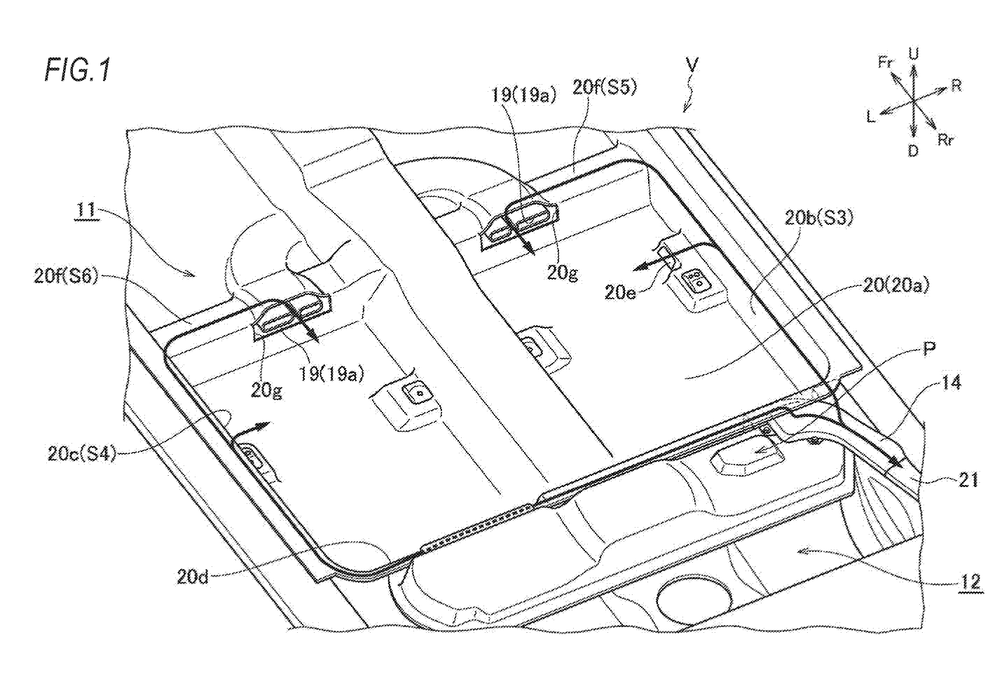

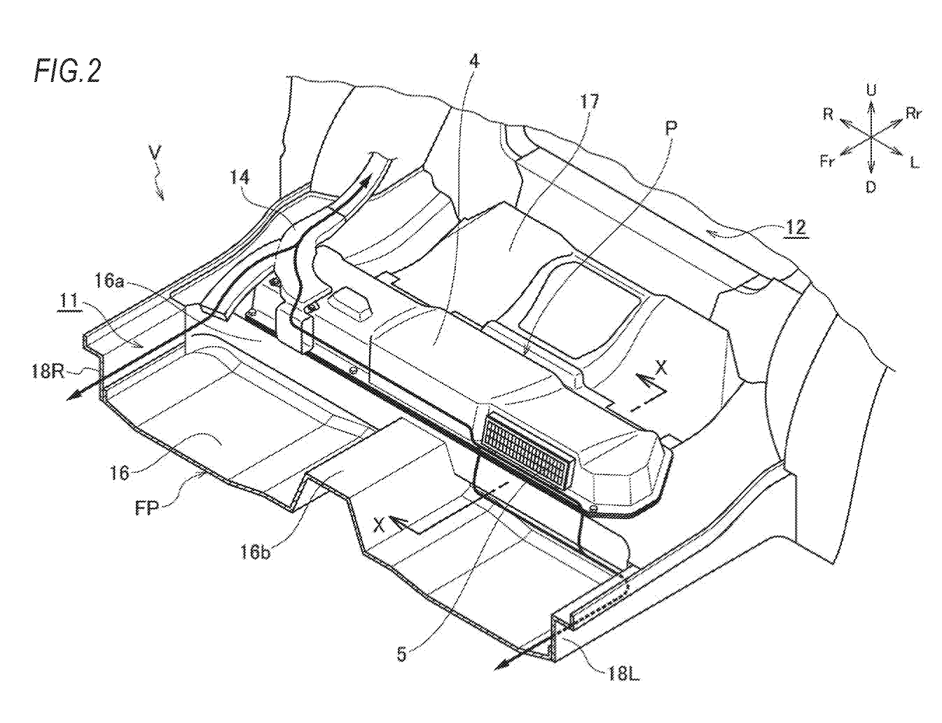

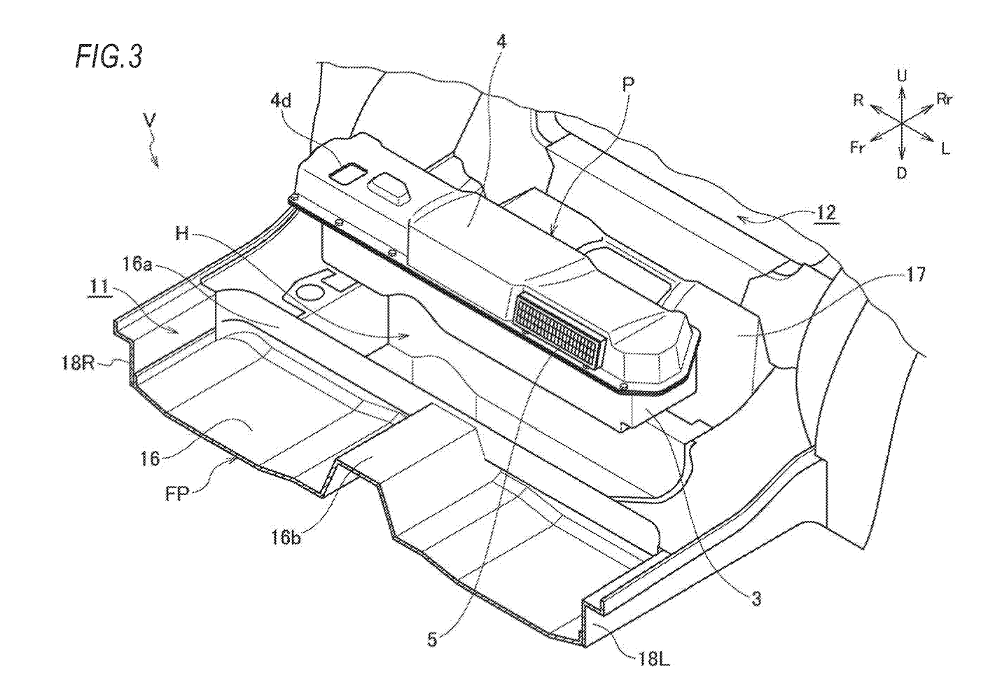

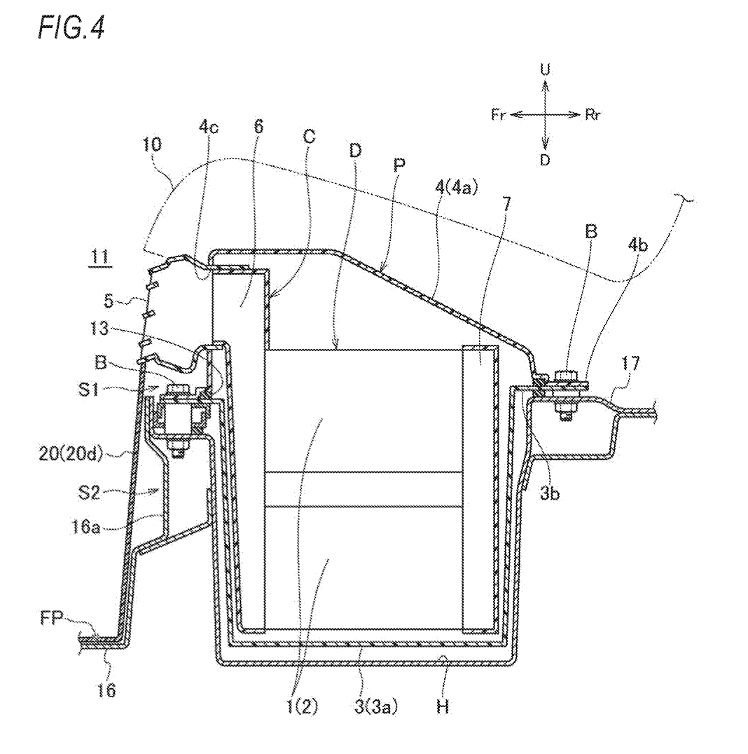

As illustrated in FIGS. 1 to 3, a vehicle V of the embodiment is, for example, a hybrid vehicle, and is mounted with a high-voltage device accommodating body P for accommodating a high-voltage device D (see FIG. 4). The high-voltage device accommodating body P is disposed in an accommodation recess H recessed in a floor panel FP and is fastened to the floor panel FP.

[High-Voltage Device Accommodating Body]

First, the high-voltage device accommodating body P will be described with reference to FIGS. 1 to 6.

The high-voltage device accommodating body P illustrated in FIGS. 1 to 6 includes a casing 3 and a lid 4 covering an opening of the casing 3, and accommodates the high-voltage device D such as a battery 1 and a cooling component C cooling down the battery 1 in an internal space thereof. The cooling component C includes an intake grill 5. an internal intake duct 6, a first internal exhaust duct 7, a cooling fan 8, and a second internal exhaust duct 9, for example.

The casing 3 is a resin member having a substantially rectangular parallelepiped shape which is long in a vehicle width direction, and includes integrally a casing body 3a which is opened to an upper side and a flange portion 3b which extends outwardly from an opening edge of the casing body 3a over the entire periphery.

The lid 4 includes integrally a lid body 4a which closes the opening of the casing body 3a and a flange portion 4b which extends outwardly from a lower end edge of the lid body 4a over the entire periphery, and supports a seat of a rear seat 10 on an upper surface of the lid body 4a. At a left side on a front surface of the lid body 4a, an intake hole 4c is formed to take cooling air into the inside of the high-voltage device accommodating body P from the passenger compartment 11. and at a right side on an upper surface of the lid body 4a, an exhaust hole 4d is formed to exhaust the cooling air used to cool down the high-voltage device D to the outside (the passenger compartment 11 and a luggage compartment 12 in the embodiment) of the high-voltage device accommodating body P.

As illustrated in FIG. 4, the flange portion 4b of the lid 4 is overlapped with the flange portion 3b of the casing 3 via an annular seal member 13. The overlapped flange portions 3b and 4b are fastened to the floor panel FP with a plurality of bolts B.

The cooling component C cools down the battery 1 with the cooling air taken into the inside of the high-voltage device accommodating body P from the passenger compartment 11 and includes a cooling airflow path that exhausts the cooling air after cooling to the outside of the high-voltage device accommodating body P.

The battery 1 is a battery module formed of a plurality of cells 2, and at least two or more batteries 1 arranged vertically in two stages are accommodated in the high-voltage device accommodating body P of the embodiment. The plurality of cells 2 are arranged in parallel with gaps (not illustrated) along a front-rear direction and are cooled down by the cooling air passing through these gaps.

The intake grill 5 is attached to the intake hole 4c formed in the lid 4, and takes the cooling air into the inside of the high-voltage device accommodating body P from the lower front of the rear seat 10. The internal intake duct 6 communicates with the intake grill 5, and covers the front surface of the battery 1. In addition, the first internal exhaust duct 7 covers the rear surface of the battery 1, and communicates with the cooling fan 8 through the internal space of the high-voltage device accommodating body P.

When the cooling fan 8 is driven, the cooling air is taken into the internal intake duct 6 from the passenger compartment 11 through the intake grill 5, and the cooling air flows into the first internal exhaust duct 7 through the gap of the battery 1, whereby the respective cells 2 of the battery 1 are cooled. Then, the cooling air, which cools down the battery 1 and flows into the first internal exhaust duct 7, is sucked into the cooling fan 8 after being discharged into the internal space of the high-voltage device accommodating body P, and is exhausted to the outside of the high-voltage device accommodating body P through the second internal exhaust duct 9.

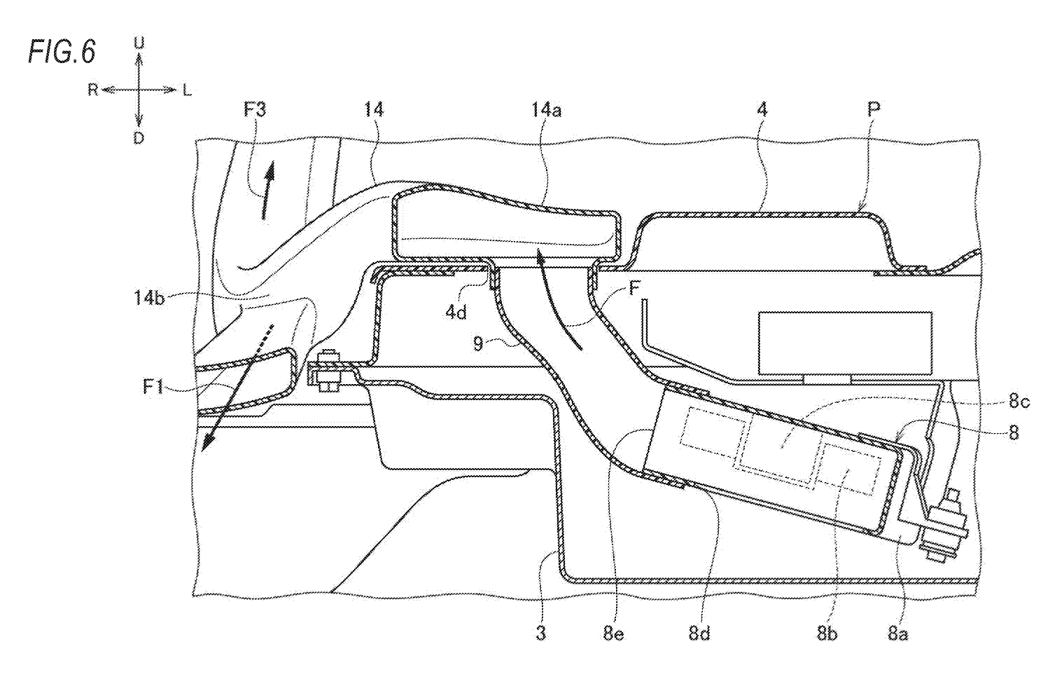

The cooling fan 8 of the embodiment is a sirocco fan, and includes a fan casing 8a, a rotating fan 8b installed in the fan casing 8a, and a motor 8c disposed at the center of the rotating fan 8b to drive rotation of the rotating fan 8b as illustrated in FIG. 6. An intake port 8d of the cooling fan 8 is formed at a lower surface of the fan casing 8a which is a direction of a rotation axis of the rotating fan 8b, and an exhaust port 8e of the cooling fan 8 is formed to protrude from the fan casing 8a along a tangential direction of the rotating fan 8b.

The cooling fan 8 is disposed in an inclined posture that rises to the right inside the high-voltage device accommodating body P such that the exhaust port 8e faces obliquely upward toward the exhaust hole 4d when sucking the cooling air used to cool down the battery 1 from the internal space of the high-voltage device accommodating body P and exhausting the sucked cooling air from the exhaust hole 4d of the lid 4 through the second internal exhaust duct 9. Then, the cooling air exhausted from the exhaust hole 4d is dispersedly exhausted to the passenger compartment 11 and the luggage compartment 12 through a branch duct 14 connected to the exhaust hole 4d.

[Floor Panel]

The floor panel FP will be described below with reference to FIGS. 1 to 4, FIG. 7, and FIG. 8.

As illustrated in FIGS. 1 to 3, the floor panel FP includes a front floor panel 16 forming a floor of the passenger compartment 11 and a rear floor panel 17 forming a floor of the luggage compartment 12. The front floor panel 16 and the rear floor panel 17 are connected to each other below the rear seat 10, and both ends thereof in the vehicle width direction are connected to a right vehicle body portion 18R and a left vehicle body portion 18L which extend in the front-rear direction of the vehicle. The accommodation recess H is recessed on the front side of the rear floor panel 17, and accommodates the high-voltage device accommodating body P.

A kick-up portion 16a is formed to rise upwardly at a rear end of the front floor panel 16, and a center tunnel 16b is formed in the front-rear direction at the center in the vehicle width direction of the front floor panel 16. The center tunnel 16b is bent such that the front floor panel 16 is projected upwardly, and an exhaust pipe (not illustrated) or the like is disposed in a trapezoidal tunnel space formed below the center tunnel to discharge the exhaust of the engine.

The floor of the passenger compartment 11 is formed in a tray-like shape having a predetermined depth by the front floor panel 16 forming a floor surface, the right vehicle body portion 18R rising from a right end of the front floor panel 16, the left vehicle body portion 18L rising from a left end of the front floor panel 16, and the kick-up portion 16a rising a rear end of the front floor panel 16. Further, a pair of left and right heater ducts 19 for blowing warm air into a foot space of the passenger compartment 11 is disposed on a front side of the floor of the passenger compartment 11. A blowing portion 19a of the heater duct 19 is located below a front seat (not illustrated) and blows warm air toward the rear side.

As illustrated in FIG. 1, a carpet 20 is laid on the floor of the passenger compartment 11. The carpet 20 includes a carpet body 20a covering the front floor panel 16 and the center tunnel 16b, a right rising portion 20b rising from the right end of the front floor panel 16 and covering the right vehicle body portion 18R, a left rising portion 20c rising from the left end of the front floor panel 16 and covering the left vehicle body portion 18L, and a rear rising portion 20d rising from the rear end of the front floor panel 16 and covering the kick-up portion 16a.

As illustrated in FIG. 4, vehicle-width-direction spaces S1 and S2 are formed along the vehicle width direction between the high-voltage device accommodating body P and the rear rising portion 20d of the carpet 20. The vehicle-width-direction space S1 is formed between the front surface of the high-voltage device accommodating body P (front surface of the lid 4) and the rear rising portion 20d of the carpet 20, and the vehicle-width-direction space S2 is formed between the front surface of the kick-up portion 16a and the rear rising portion 20d of the carpet 20. The vehicle V of the embodiment includes two kinds of vehicle-width-direction spaces S1 and S2, but may include any one of them. In addition, the vehicle-width-direction spaces S1 and S2 may communicate with each other, or may not communicate with each other.

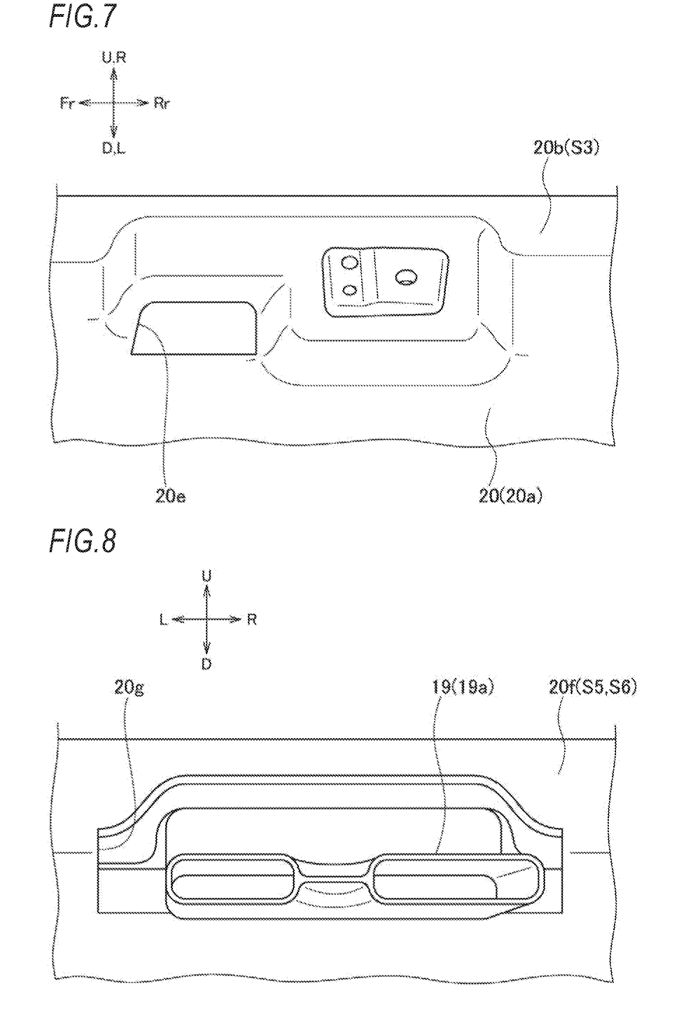

Further, a right front-rear-direction space S3 is formed along the vehicle front-rear direction between the right vehicle body portion 18R and the right rising portion 20b of the carpet 20, and a left front-rear-direction space S4 is formed along the vehicle front-rear direction between the left vehicle body portion 18L and the left rising portion 20c of the carpet 20. The left front-rear-direction space S4 communicates with the left ends of the vehicle-width-direction spaces S1 and S2 on a rear end side thereof. In addition, as illustrated in FIG. 7, the carpet 20 includes exhaust holes 20e at intermediate parts in the front-rear direction of the right rising portion 20b and the left rising portion 20c. These exhaust holes 20e allows the intermediate part in the front-rear direction of the right front-rear-direction space S3 to communicate with the passenger compartment 11, and allows the intermediate part in the front-rear direction of the left front-rear-direction space S4 to communicate with the passenger compartment 11.

Further, the carpet 20 includes left and right bulging portions 20f formed corresponding to blowing positions of the heater duct 19. The left and right bulging portions 20f cover a cross member (not illustrated) and bulge upwardly in the vehicle width direction, and the blowing portions 19a of the heater duct 19 are disposed in left and right duct peripheral spaces S5 and S6 formed between the bulging portion 20f and the front floor panel 16. As illustrated in FIG. 8, the blowing portion 19a of the heater duct 19 blows warm air to the passenger compartment 11 through a blowing hole 20g in the bulging portion 20f. In addition, the right duct peripheral space S5 communicates with the right front-rear-direction space S3 at the right end, and the left duct peripheral space S6 communicates with the left front-rear-direction space S4 at the left end.

[Exhaust Flow Path]

An exhaust flow path F of the cooling air used to cool down the high-voltage device D will be described below.

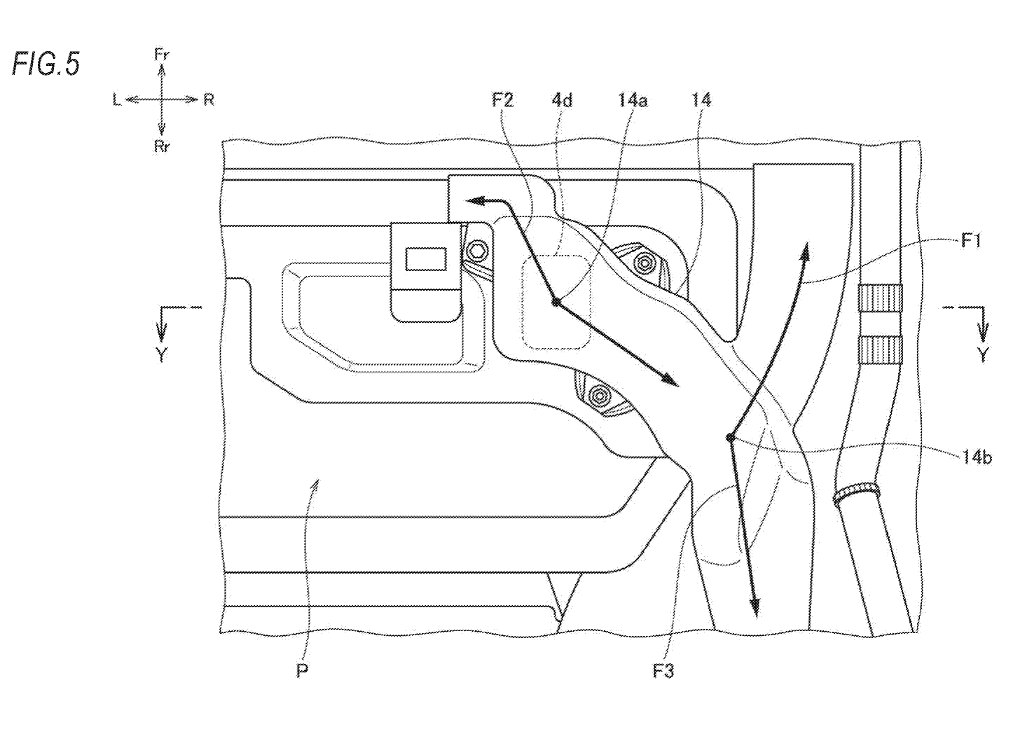

As illustrated in FIGS. 5 and 6, the cooling air exhausted from the exhaust hole 4d of the high-voltage device accommodating body P is dispersedly exhausted to the passenger compartment 11 and the luggage compartment 12 after being branched in three directions by the branch duct 14 provided on the right upper surface of the high-voltage device accommodating body P. In branching the exhaust flow path F of the cooling air into a right front exhaust flow path F1, a left front exhaust flow path F2, and a rear exhaust flow path F3, the branch duct 14 branches the exhaust flow path F into one of the left front exhaust flow path F2 and the right front exhaust flow path F1 at a first branch portion 14a, and branches it into the other of the left front exhaust flow path F2 and the right front exhaust flow path F1 and the rear exhaust flow path F3 at a second branch portion 14b downstream of the first branch portion 14a. In the embodiment, the exhaust flow path is branched into the left front exhaust flow path F2 at the first branch portion 14a and is branched into the right front exhaust flow path F1 and the rear exhaust flow path F3 at the second branch portion 14h, but may be branched into the right front exhaust flow path F1 at the first branch portion 14a and may be branched into the left front exhaust flow path F2 and the rear exhaust flow path F3 at the second branch portion 14b.

A front end of the right front exhaust flow path F1 communicates with the rear end of the right front-rear-direction space S3. Therefore, the cooling air branched to the right front exhaust flow path F1 by the branch duct 14 is exhausted from the exhaust hole 20e to the right side of the passenger compartment 11 through the right front-rear-direction space S3, and furthermore is exhausted from the blowing hole 20g to the right side of the passenger compartment 11 through the right duct peripheral space S5.

A front end of the left front exhaust flow path F2 communicates with the rear end of the left front-rear-direction space S4 through the vehicle-width-direction spaces S1 and S2. Therefore, the cooling air branched to the left front exhaust flow path F2 by the branch duct 14 is exhausted from the exhaust hole 20e to the left side of the passenger compartment 11 through the vehicle-width-direction spaces S1 and S2 and the left front-rear-direction space 54, and furthermore is exhausted from the blowing hole 20g to the left side of the passenger compartment 11 through the left duct peripheral space S6.

A front end of the rear exhaust flow path F3 communicates with a rear exhaust duct 21 directed toward the right rear side of the vehicle. Therefore, the cooling air branched to the rear exhaust flow path F3 by the branch duct 14 is exhausted to the luggage compartment 12 through the rear exhaust duct 21.

As described above, according to the vehicle V of the embodiment, since the exhaust flow path F of the cooling air used to cool down the high-voltage device D communicates with the vehicle-width-direction spaces S1 and S2 along the vehicle width direction, it is possible to disperse the cooling exhaust of the high-voltage device D in the vehicle width direction and to reduce the uncomfortable feeling of the passenger due to the unbalanced cooling exhaust.

In addition, since the vehicle-width-direction spaces S1 and S2 are formed between the high-voltage device accommodating body P and the carpet 20, it is possible to disperse the cooling exhaust in the vehicle width direction in a space-saving manner and at a low cost.

In the embodiment, the cooling exhaust of the high-voltage device D can be dispersed in the vehicle width direction using the vehicle-width-direction space S1 formed between the front surface of the high-voltage device accommodating body P and the carpet 20.

In the embodiment, the cooling exhaust of the high-voltage device D can be dispersed in the vehicle width direction using the vehicle-width-direction space S2 formed between the front surface of the kick-up portion 16a rising from the rear end of the front floor panel 16 and the carpet 20.

In the embodiment, since the cooling exhaust of the high-voltage device D is dispersed in three directions through the right front exhaust flow path F1, the left front exhaust flow path F2, and the rear exhaust flow path F3, not only the uncomfortable feeling of the passenger due to the unbalanced cooling exhaust can be further reduced but also exhaust noise can be reduced.

In the embodiment, the cooling exhaust of the high-voltage device D can be further dispersed using the right front-rear-direction space S3 formed between the right vehicle body portion 18R and the carpet 20 or the left front-rear-direction space S4 formed between the left vehicle body portion 18L and the carpet 20.

In the embodiment, the cooling air in the right front-rear-direction space S3 and the left front-rear-direction space S4 can be dispersedly exhausted to the passenger compartment 11 using the duct peripheral spaces S5 and S6.

In the embodiment, the cooling air in the right front-rear-direction space S3 and the left front-rear-direction space S4 can be dispersedly exhausted to the passenger compartment 11 from the exhaust hole 20e of the carpet 20.

In addition, since the branch duct 14 according to the embodiment branches the exhaust flow path F into one of the left front exhaust flow path F2 and the right front exhaust flow path F1 at the first branch portion 14a, and branches it into the other of the left front exhaust flow path F2 and the right front exhaust flow path F1 and the rear exhaust flow path F3 at the second branch portion 14b downstream of the first branch portion 14a, the cooling exhaust can be efficiently dispersed in three directions compared with the case of dispersing the cooling exhaust in three directions at one branch portion.

Further, since the cooling fan S of the embodiment is disposed such that the exhaust port 8e faces obliquely upward toward the branch duct 14 (exhaust hole 4d), the cooling air used to cool down the high-voltage device D can smoothly flow toward the branch duct 14 and the pressure loss can be reduced.

The present invention is not limited to the above embodiment and the modified example, and can be appropriately modified and improved.

For example, as the high-voltage device D to be the subject of the present invention, the battery 1 is exemplified in the embodiment described above, but the high-voltage device to be the subject of the present invention may be any one of a battery, a DC-DC converter, and an inverter, or a combination of two or more of them.

Further, the branch duct 14 may be disposed on the left side of the high-voltage device accommodating body P. In this case, preferably, the left front exhaust flow path F2 communicates with the left front-rear-direction space S4, the right front exhaust flow path F1 communicates with the right front-rear-direction space S3 through the vehicle-width-direction spaces S1 and S2, and the rear exhaust flow path F3 communicates with the rear exhaust duct 21 directed toward the left rear side of the vehicle.

This application is based upon and claims the benefit of priority from Japanese Patent Application No. 2015-237805, filed Dec. 04, 2015, the entire contents of which are incorporated herein by reference.

### DESCRIPTION OF REFERENCE NUMERALS AND CHARACTERS

8 cooling fan
8a fan casing
8b rotating fan
8c motor
8d intake port
8e exhaust port
10 rear seat
11 passenger compartment
14 branch duct (branch member)
14a first branch portion
14b second branch portion
16 front floor panel (floor panel)
16a kick-up portion
18L left vehicle body portion
18R right vehicle body portion
19 heater duct
20 carpet
20e exhaust hole
21 rear exhaust duct
D high-voltage device
F exhaust flow path
F1 right front exhaust flow path
F2 left front exhaust flow path
F3 rear exhaust flow path
P high-voltage device accommodating body (high-voltage device accommodating portion)
S1, S2 vehicle-width-direction space
S3 right front-rear-direction space
S4 left front-rear-direction space
S5, S6 duct peripheral space
V vehicle

1. A vehicle comprising:
a floor panel that forms a floor of a passenger compartment;
a carpet that is laid on the floor panel;
a rear seat that is disposed at a rear part of the passenger compartment;
a high-voltage device accommodating portion that is disposed below the rear seat and accommodates a high-voltage device; and
an exhaust flow path that exhausts cooling air used to cool down the high-voltage device from the high-voltage device accommodating portion, wherein
a vehicle-width-direction space is formed between the high-voltage device accommodating portion and the carpet along a vehicle width direction, and the exhaust flow path communicates with the vehicle-width-direction space.

2. The vehicle according to claim 1, wherein
the vehicle-width-direction space is formed between a front surface of the high-voltage device accommodating portion and the carpet.

3. The vehicle according to claim 1, wherein
the vehicle-width-direction space is formed between a front surface of a kick-up portion rising from a rear end of the floor panel and the carpet.

4. The vehicle according to claim 1, further comprising:
a branch member that branches the exhaust flow path into a right front exhaust flow path, a left front exhaust flow path, and a rear exhaust flow path, wherein
the cooling air is exhausted into an inside of the vehicle through the right front exhaust flow path, the left front exhaust flow path, and the rear exhaust flow path.

5. The vehicle according to claim 4, further comprising:
a right vehicle body portion that rises from a right end of the floor panel;
a left vehicle body portion that rises from a left end of the floor panel;
a right front-rear-direction space that is formed along a vehicle front-rear direction between the right vehicle body portion and the carpet; and
a left front-rear-direction space that is formed along the vehicle front-rear direction between the left vehicle body portion and the carpet, wherein
the branch member is disposed on a right side of the high-voltage device accommodating portion,
the right front exhaust flow path communicates with the right front-rear-direction space,
the left front exhaust flow path communicates with the left front-rear-direction space through the vehicle-width-direction space, and
the rear exhaust flow path communicates with a rear exhaust duct directed toward a right rear side of the vehicle.

6. The vehicle according to claim 4, further comprising:
a right vehicle body portion that rises from a right end of the floor panel;
a left vehicle body portion that rises from a left end of the floor panel;
a right front-rear-direction space that is formed along a vehicle front-rear direction between the right vehicle body portion and the carpet; and
a left front-rear-direction space that is formed along the vehicle front-rear direction between the left vehicle body portion and the carpet, wherein
the branch member is disposed on a left side of the high-voltage device accommodating portion,
the left front exhaust flow path communicates with the left front-rear-direction space,
the right front exhaust flow path communicates with the right front-rear-direction space through the vehicle-width-direction space, and
the rear exhaust flow path communicates with a rear exhaust duct directed toward a left rear side of the vehicle.

7. The vehicle according to claim 5, further comprising:
a heater duct that blows warm air into a foot space of the passenger compartment, wherein
the right front-rear-direction space and the left front-rear-direction space communicate with a duct peripheral space formed between the heater duct and the carpet, and
the cooling air in the right front-rear-direction space and the left front-rear-direction space is exhausted to the passenger compartment through the duct peripheral space.

8. The vehicle according to claim 5, wherein
the carpet includes an exhaust hole through which the cooling air in the right front-rear-direction space and the left front-rear-direction space is exhausted to the passenger compartment.

9. A vehicle comprising:
a rear seat that is disposed at a rear part of a passenger compartment;
a high-voltage device accommodating portion that is disposed below the rear seat and accommodates a high-voltage device; and
an exhaust flow path that exhausts cooling air used to cool down the high-voltage device from the high-voltage device accommodating portion, wherein
the vehicle further includes a branch member that branches the exhaust flow path into a right front exhaust flow path, a left front exhaust flow path, and a rear exhaust flow path, and
the cooling air is exhausted into the vehicle through the right front exhaust flow path, the left front exhaust flow path, and the rear exhaust flow path.

10. The vehicle according to claim 9, wherein
the branch member branches the exhaust flow path into one of the left front exhaust flow path and the right front exhaust flow path at a first branch portion, and branches the exhaust flow path into the other of the left front exhaust flow path and the right front exhaust flow path and the rear exhaust flow path at a second branch portion in a downstream of the first branch portion.

11. The vehicle according to claim 9, wherein
the high-voltage device accommodating portion accommodates a cooling fan therein,
the cooling fan includes a fan casing, a rotating fan installed in the fan casing, and a motor disposed at a center of the rotating fan to drive rotation of the rotating fan,
an intake port is formed at a lower surface of the fan casing which is a direction of a rotation axis of the rotating fan,
an exhaust port is formed at a side surface of the fan casing so as to extend along a tangential direction of the rotating fan, and
the cooling fan is disposed such that the exhaust port faces obliquely upward toward the branch member.
